(19) United States
(12) Patent Application Publication
(10) Pub. No.: US 2024/0378754 A1
(43) Pub. Date: Nov. 14, 2024

(54) CALIBRATION OF ACTUATION MECHANISM

(71) Applicant: CAMBRIDGE MECHATRONICS LIMITED, Cambridge, Cambridgeshire (GB)

(72) Inventors: Yannis Koveos, Cambridge (GB); David Richards, Cambridge (GB)

(21) Appl. No.: 18/692,927

(22) PCT Filed: Sep. 28, 2022
(86) PCT No.: PCT/GB2022/052459

§ 371 Date: Mar. 18, 2024

(30) Foreign Application Priority Data
Sep. 28, 2021 (GR) 20210100643
Nov. 17, 2021 (GB) 2116593.1

(51) Int. Cl. G06T 7/80; G01S 7/497

(52) U.S. Cl. CPC G06T 7/80; G01S 7/497

(57) ABSTRACT

Embodiments of the present techniques provide apparatus and methods for calibrating the actuation mechanism (506) of an imaging system (500) for generating a three-dimensional (3D) representation of a scene (508). In particular, the present techniques provide for setting the gain of for the actuation mechanism (506) to a plurality of different gain values, determining a fill-factor for the field of view associated with each of the different gain values and determining a calibrated gain value based on the results. An apparatus (500) comprises a light source (502), e.g. a VCSEL array. The light emitted by the light source (502) passes through one or more optical elements (504), e.g. lenses, mirrors, diffraction gratings, etc., before being emitted from the apparatus (500) and projecting onto the scene/object field (508). The apparatus (500) comprises a receiver lens and filter system (510), and a multipixel sensor/detector (512) for sensing reflected light. One or more of the optical elements (504) are coupled to an actuation mechanism (506). The actuation mechanism (506) moves the optical element (504) to which it is coupled. The extent by which the optical element (504) is moved depends on the gain for the actuation mechanism (506). A control signal is provided to the actuation mechanism (506). The control signal is amplified by the gain. The amplified signal is applied to the actuation mechanism (506). Applying the gain calibration techniques to a structured-light 3D scanner may be used to increase the fill-factor.

The present application generally relates to an apparatus for generating a three-dimensional (3D) representation of a scene (also known as 3D sensing) and methods for calibrating the actuation mechanism of such an apparatus.

In a first approach of the present techniques, there is provided an apparatus for use in generating a three-dimensional representation of a scene, the apparatus comprising: an imaging camera system comprising a multipixel sensor and a light source and arranged to emit illumination having a spatially-nonuniform intensity over the field of view of the sensor; an actuation mechanism for moving the illumination across at least part of the field of view, wherein a gain for the actuation mechanism controls the extent to which the illumination is moved in response to a signal provided to the actuation mechanism; and a controller configured to calibrate the actuation mechanism, the controller arranged to: set the gain to each of a plurality of different gain values; for each of the different gain values, control the actuation mechanism to move the illumination in a scanning pattern across at least part of the field of view, and determine a fill-factor indicative of a proportion of the field of view covered by the illumination during a cycle of the scanning pattern; and determine a calibrated gain value based on the determined fill-factors associated with the different gain values. This may be achieved without measuring actuator motion directly and/or trying to measure the projected pattern externally.

The non-uniform illumination may be any form of illumination, including a beam of light, a pattern of light, a striped pattern of light, a dot pattern of light. It will be understood that these are merely example types of illumination and are non-limiting.

The apparatus may be (or may be included in) any of: a smartphone, a mobile computing device, a laptop, a tablet computing device, a security system, a gaming system, an augmented reality system, an augmented reality device, a wearable device, a drone, an aircraft, a spacecraft, a vehicle, an autonomous vehicle, a robotic device, a consumer electronics device, a domotic device, and a home automation device, for example.

In a second approach of the present techniques, there is provided a method for calibrating an actuation mechanism of an apparatus for use in generating a three-dimensional representation of a scene, the method comprising: controlling an imaging camera system of the apparatus comprising a multipixel sensor and a light source to emit illumination having a spatially-nonuniform intensity over the field of view of the sensor; setting a gain for the actuation mechanism to each of a plurality of different gain values, wherein the gain controls the extent to which the illumination is moved in response to a signal provided to the actuation mechanism; for each of the different gain values, controlling the actuation mechanism to move the illumination in a scanning pattern across at least part of the field of view of the sensor, and determining a fill-factor indicative of a proportion of the field of view of the sensor covered by the illumination during a cycle of the scanning pattern; and determining a calibrated gain value based on the determined fill-factors associated with the different gain values.

The apparatus described herein may be used for a number of technologies or purposes (and their related devices or systems), such as 3D sensing, depth mapping, aerial surveying, terrestrial surveying, surveying in or from space, hydrographic surveying, underwater surveying, scene detection, collision warning, security, facial recognition, augmented reality, advanced driver-assistance systems in vehicles, autonomous vehicles, gaming, gesture control/recognition, robotic device control, touchless technology, and home automation. It will be understood that this is a non-exhaustive list of example technologies which may benefit from utilising the present apparatus.

In a related approach of the present techniques, there is provided a non-transitory data carrier carrying processor control code to implement any of the methods described herein.

Preferred features are set out in the appended dependent claims.

As will be appreciated, the present techniques may be embodied as a system, method or computer program product. Accordingly, present techniques may take the form of an entirely hardware embodiment, an entirely software embodiment, or an embodiment combining software and hardware aspects.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier. The code may be provided on a carrier such as a disk, a microprocessor, CD-or DVD-ROM, programmed memory such as non-volatile memory (e.g. Flash) or read-only memory (firmware), or on a data carrier such as an optical or electrical signal carrier. Code (and/or data) to implement embodiments of the techniques described herein may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog (RTM) or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

It will also be appreciated that all or part of a logical method according to embodiments of the present techniques may suitably be embodied in a logic apparatus comprising logic elements to perform the steps of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In some embodiments, the present techniques may be realised in the form of a data carrier having functional data thereon, said functional data comprising functional computer data structures to, when loaded into a computer system or network and operated upon thereby, enable said computer system to perform all the steps of the above-described method.

Implementations of the present techniques will now be described, by way of example only, with reference to the accompanying drawings, in which:

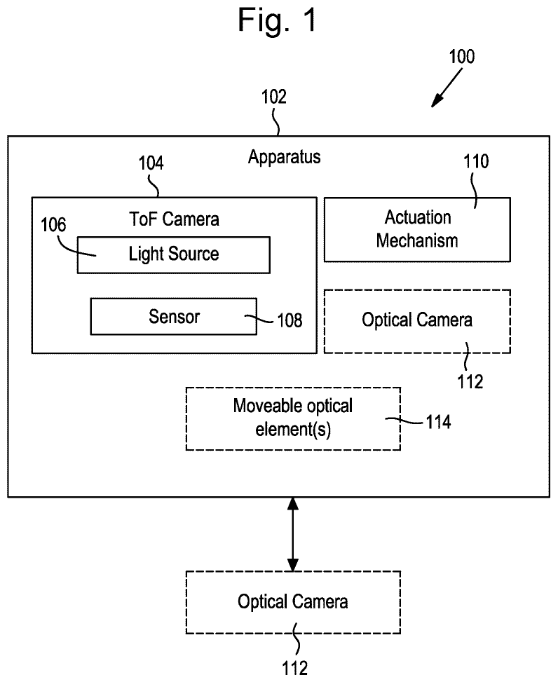

FIG. 1 shows a schematic diagram of an apparatus or system for generating a three-dimensional (3D) representation of a scene using a time-of-flight (ToF) camera;

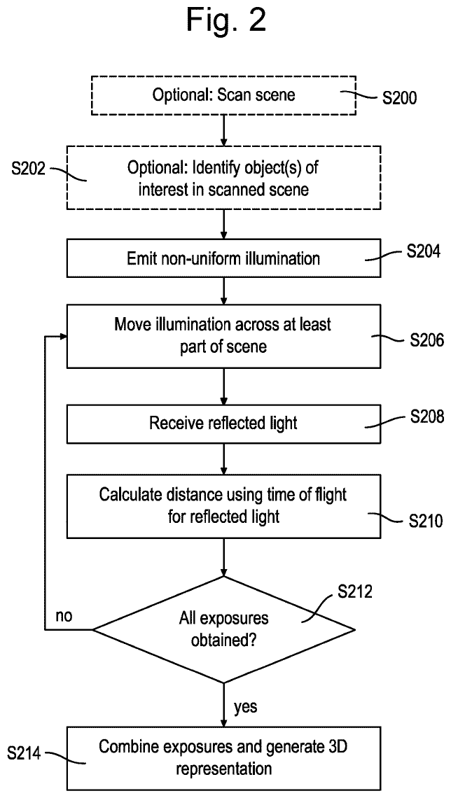

FIG. 2 shows a flowchart of example steps for generating a 3D representation of a scene;

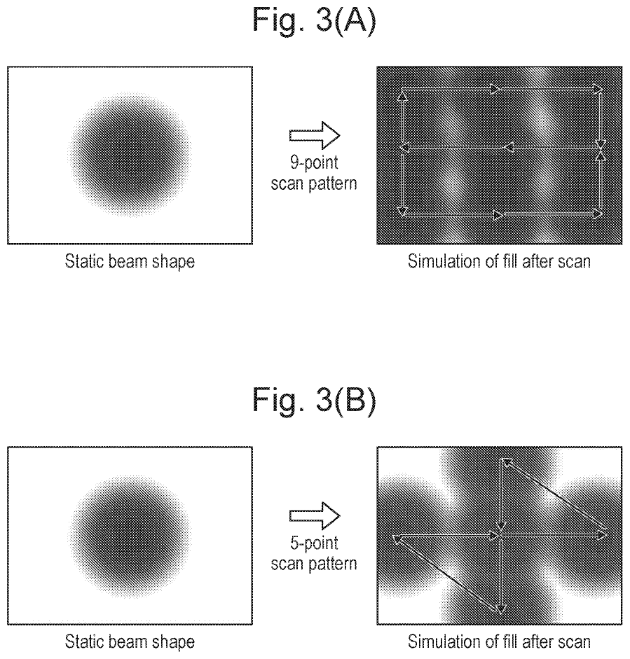

FIGS. 3A and 3B respectively show a nine-point and a five-point scanning pattern using circular illumination

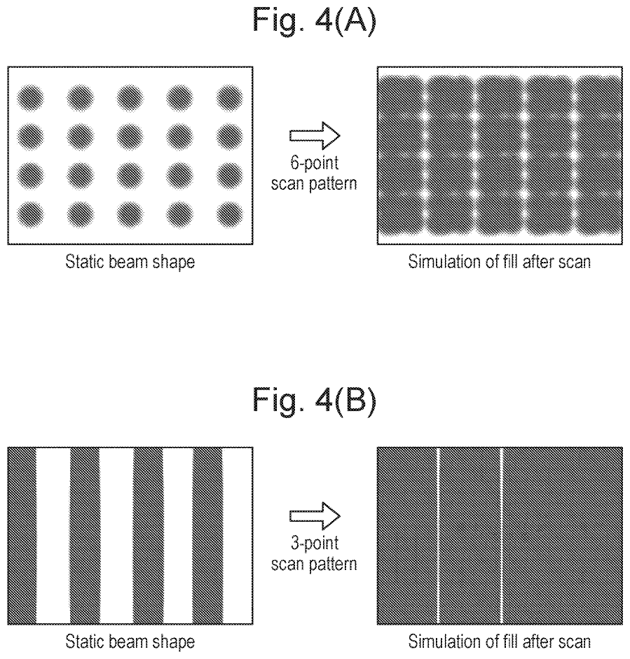

FIG. 4A shows a six-point scanning pattern using a dot pattern of light;

FIG. 4B shows a three-point scanning pattern using a striped light pattern;

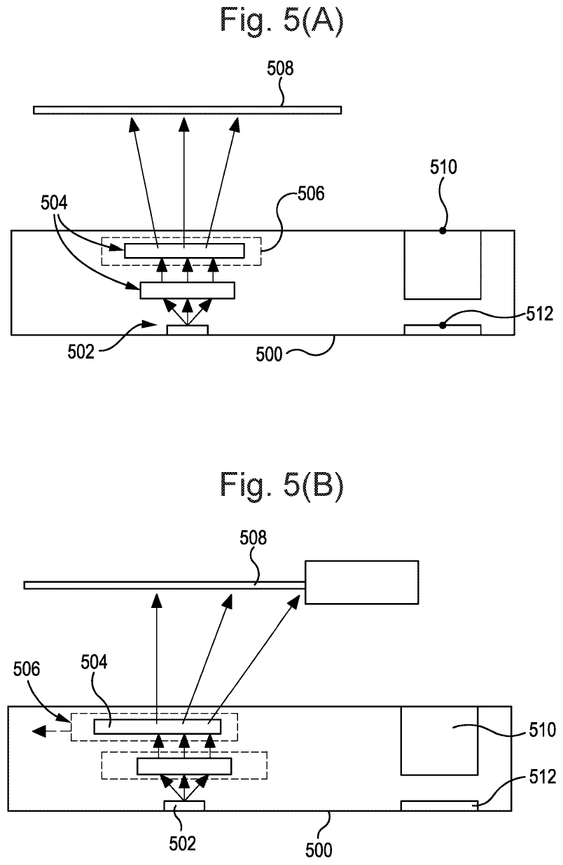

FIGS. 5A and 5B respectively show a block diagram of an apparatus for generating a 3D representation in which illumination is directed on the centre of a scene and on the right-side of the scene;

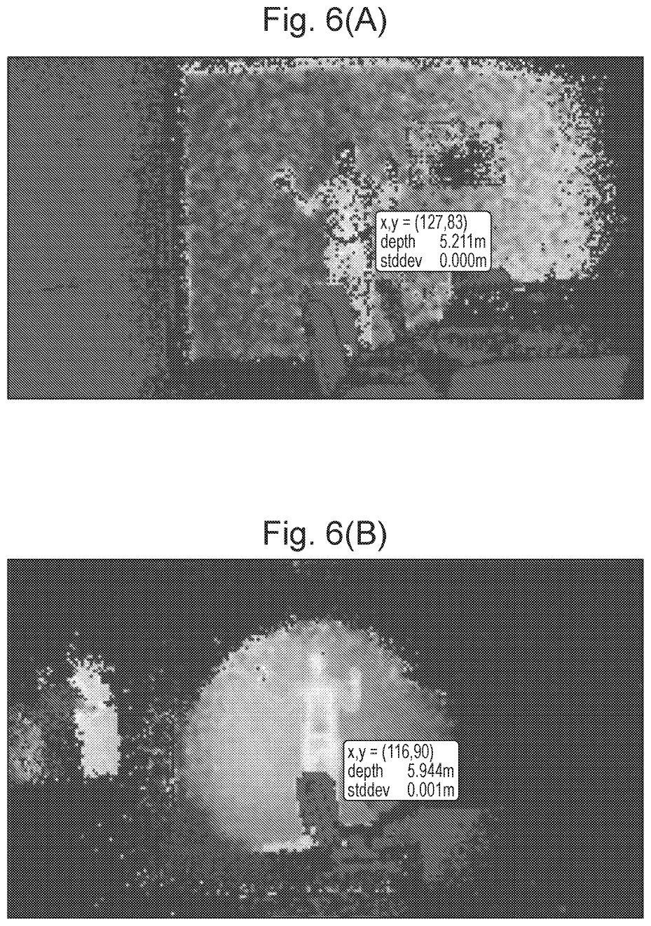

FIGS. 6A and 6B respectively show images captured by a ToF imaging system emitting uniform illumination and non-uniform illumination;

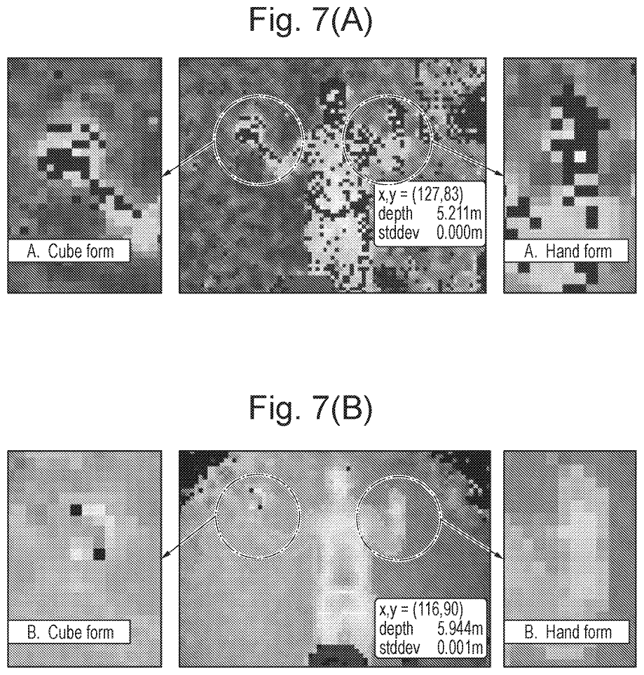

FIGS. 7A and 7B respectively show a zoomed-in view of the images shown in FIGS. 6A and 6B;

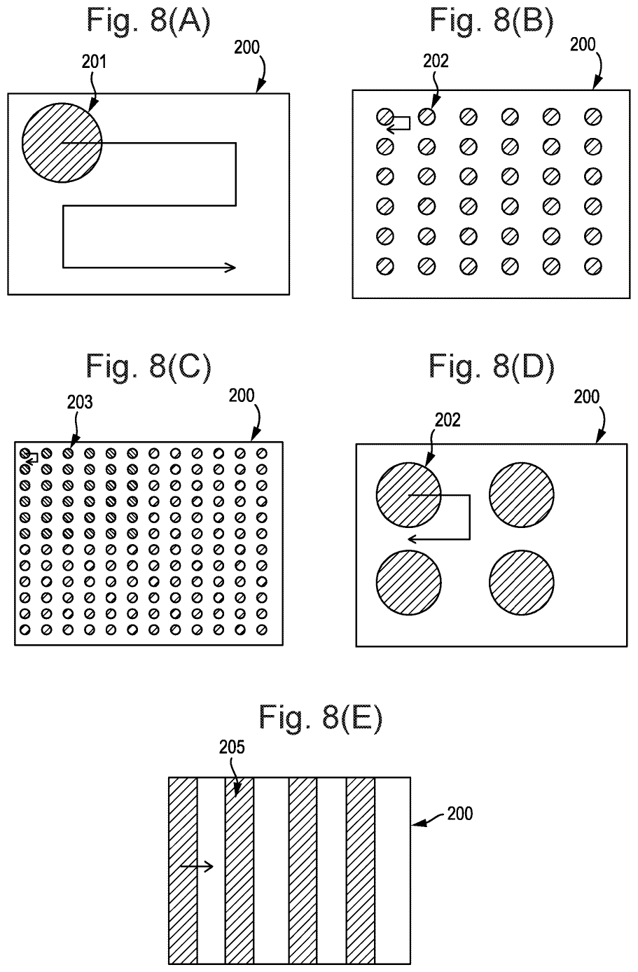

FIGS. 8A-E are schematic representations of several illumination patterns;

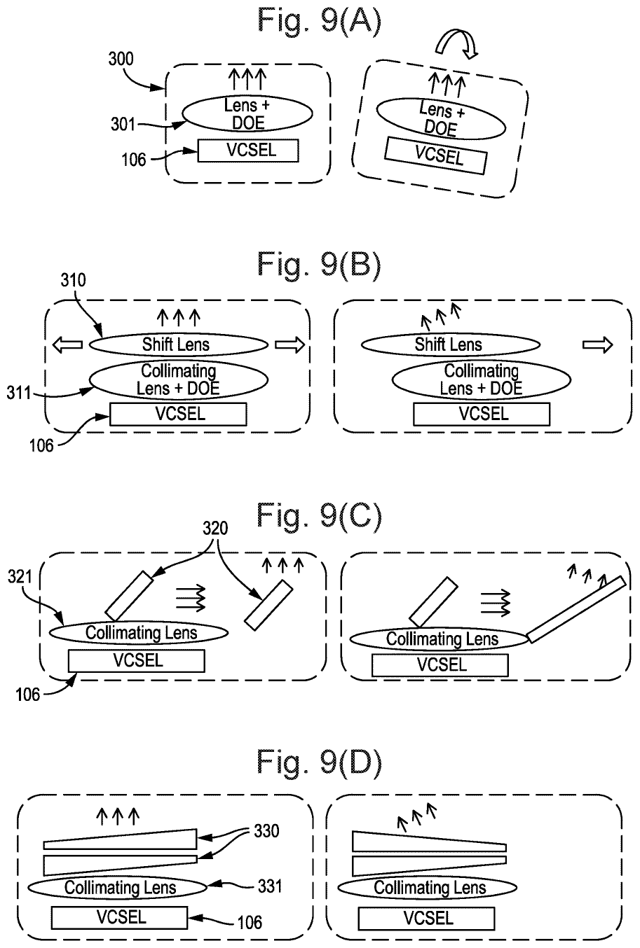

FIGS. 9A-D are schematic representations of various configurations which may be used to produce one or more of the illumination patterns of FIGS. 8A-E;

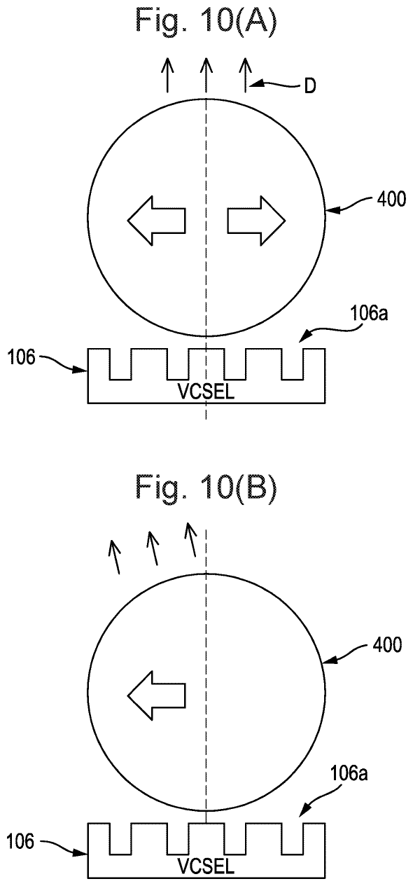

FIGS. 10A and B are schematic representations of a configuration in which a ball lens is used to move an illumination pattern as per FIG. 8;

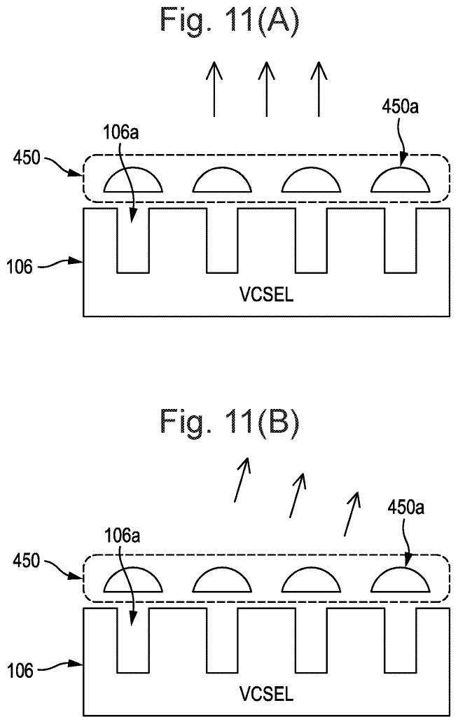

FIGS. 11A and 11B are schematic representations of a configuration in which a microlens array is used to move an illumination pattern as per FIG. 8;

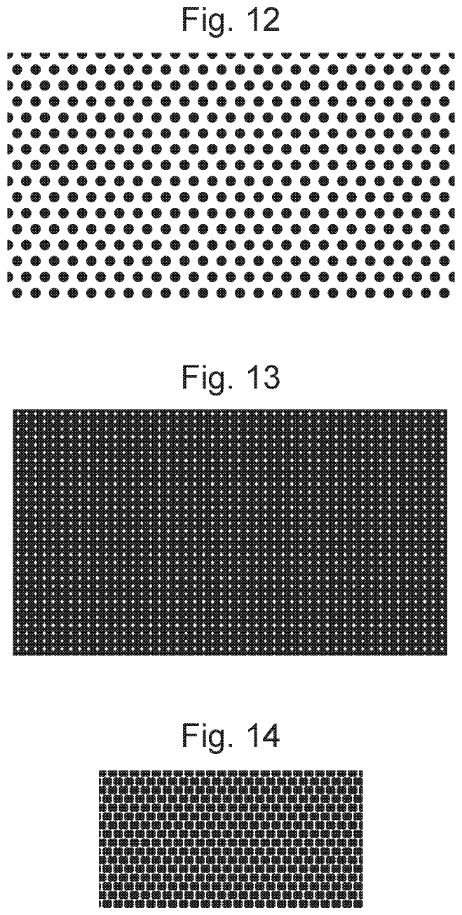

FIG. 12 shows a dot pattern of light;

FIG. 13 shows a scanning pattern using the dot pattern shown in FIG. 12;

FIG. 14 shows another scanning pattern using the dot pattern shown in FIG. 12;

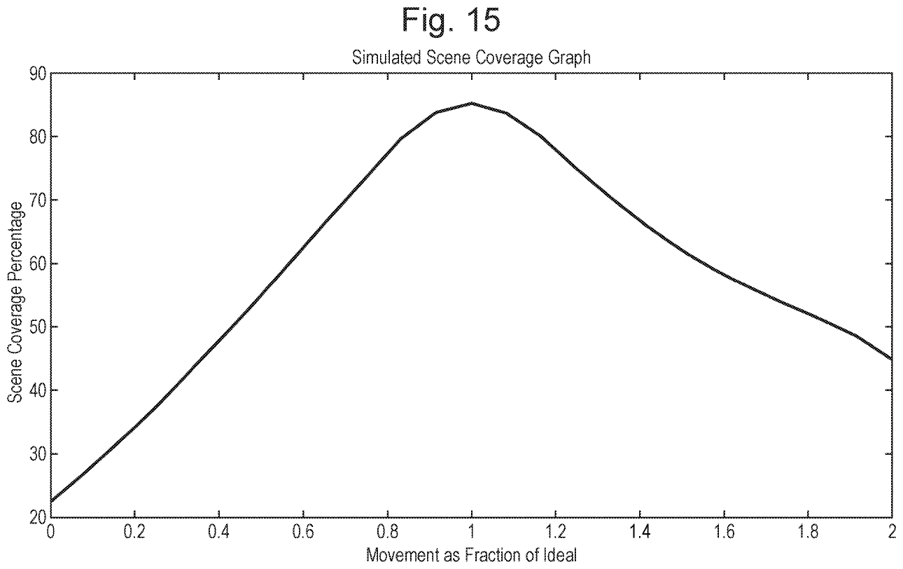

FIG. 15 is a graph to show the relationship between gain for the actuation mechanism and fill-factor for the field of view of the sensor; and

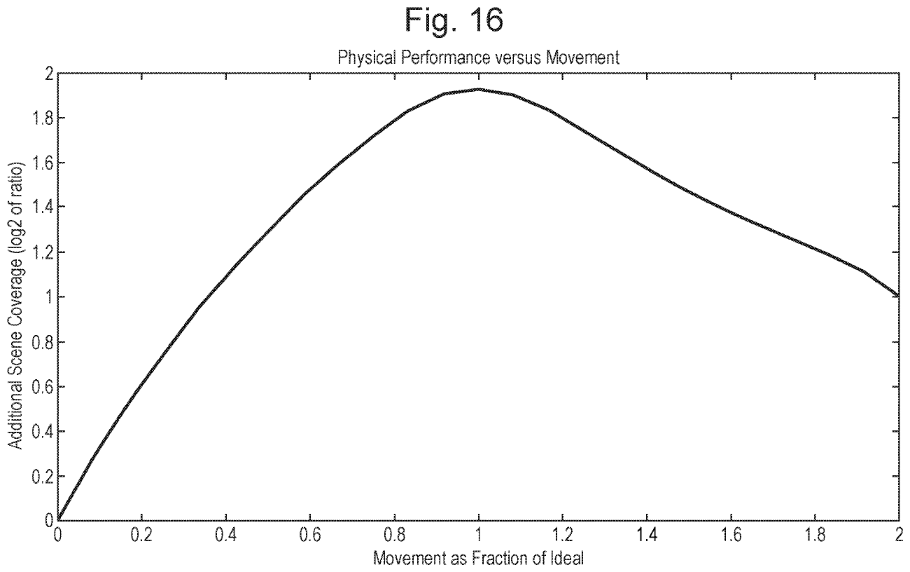

FIG. 16 is a graph to show the relationship between gain for the actuation mechanism and fill-factor for the field of view of the sensor.

Broadly speaking, embodiments of the present techniques provide apparatus and methods for calibrating the actuation mechanism of an imaging system for generating a three-dimensional (3D) representation of a scene (also known as 3D sensing). In particular, the present techniques provide for setting the gain of for the actuation mechanism to a plurality of different gain values, determining a fill-factor for the field of view associated with each of the different gain values and determining a calibrated gain value based on the results.

Time-of-flight (ToF) camera systems are known for measuring long distances—they are, for example, used to measure distance in building surveys. Time of flight camera systems work by estimating the time taken for a pulse of light to travel from an emitter to a sensor/receiver/detector. The estimate of time (in seconds) can be converted into a distance (in metres) simply by multiplying the time by half the speed of light (i.e. 1.5×10⁸ ms⁻¹). The time measurement in this system will need to be both accurate and precise, preferably with at least nanosecond resolution.

Invisible light wavelengths may be used for ToF camera systems to avoid disturbing the scene that is being imaged (which may also be being captured with a visible light camera). The Near Infrared [NIR] band (wavelengths 750 nm to 1.4 μm) is typically chosen due to the availability of small (portable) lasers with good resolving potential, whilst being free of absorption lines.

There are several different mechanisms for detecting time of flight, but most practical 2D sensors work on a modulation principle where many pulses of light are emitted and the phase shift of the received light is measured. Modulation frequencies are typically in the range 1 to 100 MHz (i.e. pulses of 10 ns to 1 μs) and that, in turn, determines the maximum range which can be measured (due to the inability to distinguish time aliases). A modulation of 1 to 100 MHz corresponds to a maximum range of roughly 150 m to 1.5 m (respectively).

It is possible to design cameras with the required level of performance under ideal conditions, but practical signal-to-noise levels reduce the available performance most particularly in terms of depth range and depth resolution. The typical issue is that other sources of illumination, and especially direct sunlight, increase background illumination which can swamp the time of flight signal and make detection of time of flight more difficult (noisier) or impossible (no detection at all). Output power from the illumination source cannot typically be increased due to both power constraints (devices are typically operating in the 1-8W instantaneous power range), and because there may be strict limits on optical power output from lasers to prevent user injury.

Certain applications require accurate depth measurement at long distances. For example, artificial and augmented reality systems and collision detection systems in vehicles or robotic devices, may require accurate depth measurement over a long range, e.g. 10 cm depth resolution at a distance of 10 m away from the imaging system.

Indirect time-of-flight cameras typically attempt to flood-illuminate the object field, and may have a viewing angle of 60×45°. This may be achieved using a VCSEL array (vertical-cavity surface-emitting laser array) as the light source, and a diffuser to ensure an even spread of illumination over the object field. Given the electrical and optical power constraints of a typical ToF camera system, this may mean that good quality depth-sensing capability is limited to a distance of around 4 metres, and so when the object is e.g. 6 metres away no useful depth information is returned at all.

In order to increase the density of illumination output by the camera system, the emitted light is moved around the scene being imaged, using the actuation mechanism.

The actuation mechanism associated with the imaging camera system controls the position of illumination emitted by the camera system. The actuation mechanism has at least one associated gain. The gain controls the extent to which the illumination is caused to be moved by the actuation mechanism for a given level of signal provided to the actuation mechanism. For example, a signal may be provided to the actuation mechanism indicative of a current provided to the actuation mechanism. The current signal is amplified by the value of the gain. The amplified signal is applied to the actuation mechanism. For example, a greater gain value may correspond to a greater distance that the illumination is moved for a given current signal.

The actuation mechanism may comprise at least one shape memory alloy (SMA) actuator wire. The wire is provided with a current that may heat the wire, causing the wire to change in length. The change in length results in actuation of the imaging camera system. A greater current applied to the wire may correspond to a greater actuation. The gain controls the amount of actuation for a given input signal that is amplified by the gain. The actuation mechanism may have more than one associated gain. For example, there may be an independently controllable gain for each degree of freedom. For example, there may be one gain that affects movement of the illumination along one axis, and another gain that affects movement of the illumination along another axis.

It is desirable to calibrate the gain so that the movement of the illumination can be more accurately controlled. This can help to increase the coverage of the field of view of the sensor by the emitted light as it is scanned across the field of view.

Accordingly, the present applicant has identified the need for an improved calibration for the actuation mechanism for 3D sensing.

A PMD Flexx ToF system comprising a VCSEL array was tested to determine how the resolution of a ToF-based 3D sensing system may be improved for longer distances. The ToF system was set-up to image a person standing at least 5 metres away from the system, with their left hand thumb splayed out and holding a ˜10 cm cube in their right hand. The system was set to capture 5 fps (frames per second) for all tests. The tests sought to determine whether it was possible to clearly distinguish (i) the person's general body form, (ii) the left hand shape and individual fingers of the left hand, and (iii) the cube shape, at a variety of distances using uniform and non-uniform illumination.

FIG. 6A shows an image captured by the ToF imaging system when the ToF system emits uniform illumination at the person being imaged was ˜5.2 metres away from the camera. This shows that the entire scene is well-illuminated by the ToF imaging system. FIG. 6B shows an image captured by the ToF imaging system when the ToF system emits (spatially-) non-uniform illumination. The non-uniform illumination was achieved by removing the diffuser from the ToF system. In FIG. 6B, the person being imaged was ˜6 metres away from the camera. This shows that the centre of the scene is better illuminated than the edges of the scene (i.e. has increased central scene illumination), but, as a result, the accuracy and/or range of the depth information at the centre of the scene is improved.

FIGS. 7A and 7B respectively show a zoomed-in view of the images shown in FIGS. 6A and 6B. With respect to determining (i) the person's general body form, FIG. 7A (uniform illumination) shows a coarse body form and poor depth distinction, whereas FIG. 7B (non-uniform illumination) shows a more clear, distinct body form and clear change in depth from the middle of the person's torso to the edge of their torso. With respect to determining (ii) the left hand shape and individual fingers of the left hand, the hand shape is not well defined in FIG. 7A, but in FIG. 7B the hand shape is clearer and the thumb is just noticeable. With respect to determining (iii) the cube shape, the cube is distorted in FIG. 7A, while the cube's square edge form is more noticeable in FIG. 7B. Thus, the tests indicate that there is improvement in the accuracy of the depth information of a ToF based 3D sensing system at increased distances if the majority of the illumination is focussed on ˜25% of the field of view. More generally, the illumination may be focussed on between ˜1% and ˜50% of the field of view or between ˜10% and ˜40% of the field of view or between ˜20% and ˜30% of the field of view.

By removing the diffuser of a typical ToF camera system, non-uniform illumination is emitted by the system (i.e. the illumination is higher at the centre than at the edges), and furthermore, the modified camera system allows more accurate depth information to be obtained at an increased distance (e.g. 7 metres or more). Electrical power and total optical flux through the exit pupil of the camera system are unaltered, but the peak illumination in the object field is increased. In this sense, a trade-off has been achieved between coverage of the field of view on the one hand and Z (depth) range and/or accuracy on the other.

In order to compensate for the loss of XY illumination in the object field, the actuation mechanism moves the emitted light around the scene being imaged.

The actuation mechanism can be calibrated by testing and directly measuring the actuation mechanism before it is incorporated with the imaging camera system into the apparatus. Such a calibration method slows down the production line for the apparatus. Furthermore it is only possible to perform such a calibration method before the apparatus is completely manufactured (at which point the actuation mechanism is not sufficiently accessible to be tested). It has also been found that the actuation mechanism can be affected by factors that continue to vary after the apparatus has been completely manufactured, for example ageing, contamination (e.g. by dust particles) and the environment (e.g. temperature).

Thus, the present techniques provide an apparatus for use in generating a three-dimensional representation of a scene, the apparatus comprising: an imaging camera system comprising a multipixel sensor and a light source and arranged to emit illumination having a spatially-nonuniform intensity over the field of view of the sensor; an actuation mechanism for moving the illumination across at least part of the field of view, wherein a gain for the actuation mechanism controls the extent to which the illumination is moved in response to a signal provided to the actuation mechanism; and a controller configured to calibrate the actuation mechanism, the controller arranged to: set the gain to each of a plurality of different gain values; for each of the different gain values, control the actuation mechanism to move the illumination in a scanning pattern across at least part of the field of view, and determine a fill-factor indicative of a proportion of the field of view covered by the illumination during a cycle of the scanning pattern; and determine a calibrated gain value based on the determined fill-factors associated with the different gain values.

Turning now to FIG. 1, this shows a schematic diagram of an apparatus 102 or system 100 for generating a three-dimensional (3D) representation of a scene using camera, which may be a time-of-flight (ToF) camera. For example, the apparatus 102 may be, or may be included in, any of: a smartphone, a mobile computing device, a laptop, a tablet computing device, a security system, a gaming system, an augmented reality system, an augmented reality device, a wearable device, a drone, an aircraft, a spacecraft, a vehicle, an autonomous vehicle, a robotic device, a consumer electronics device, a domotic device, and a home automation device.

The apparatus 102 comprises a camera, which may be a ToF camera 104 comprising a light source 106 and arranged to emit non-uniform illumination. The ToF camera 104 may comprise a multipixel sensor or detector 108 for receiving reflected light from a field of view.

The non-uniform illumination may be any form of illumination, and may be provided/emitted by any suitable light source 106. For example, the light source 106 may be a source of non-visible light or a source of near infrared (NIR) light, for the reasons explained above. The light source 106 may comprise at least one laser, laser array (e.g. a VCSEL array), or may comprise at least one light emitting diode (LED). The non-uniform illumination emitted by the light source 106 (or by the overall apparatus 100) may have any form or shape. For example, the non-uniform illumination may be a light beam having a circular beam shape (as shown on the left-hand side of FIG. 3A for example), or may comprise a pattern of parallel stripes of light (as shown on the left-hand side of FIG. 4B for example), or may comprise a uniform or non-uniform pattern of dots or circles of light (as shown on the left-hand side of FIG. 4A for example). It will be understood that these are merely example types of illumination and are non-limiting.

Generally speaking, if an increase in range by a factor of two is required, then four times more illumination intensity in the far-field (object field) will be required in order to preserve signal-to-noise ratio.

The apparatus 102 comprises an actuation mechanism 110 for moving the emitted non-uniform illumination across at least part of the field of view of the sensor 108. The actuation mechanism 110 may be any suitable actuation mechanism for incorporation into the apparatus 102 and for use in an imaging system. For example, the actuation mechanism 110 may be a SMA actuation system, which comprises at least one SMA actuator wire. The at least one SMA actuator wire may be coupled to the or each element of the apparatus 102 which may be moved in order to move the emitted non-uniform illumination across at least part of the scene. Additionally or alternatively, the actuation mechanism 110 may comprise a voice coil motor (VCM), or an adaptive beam-steering mechanism for steering the non-uniform illumination (which may comprise an electrically switchable spatial light modulator). The actuation mechanism 110 may be arranged to move the emitted non-uniform illumination by moving any one of the following components of the apparatus 102 or ToF camera 104: a lens, a prism, a mirror, a dot projector, and the light source 106.

In embodiments, the apparatus 102 may comprise at least one moveable optical element 114 which is provided ‘in front of’ the light source 106, i.e. between the light source 106 and the object field/scene. The actuation mechanism 110 may be arranged to spin or rotate, or otherwise move, the optical element 114 in order to move the emitted non-uniform illumination. The optical element 114 may be any one of: a lens, a prism, a mirror, and a diffraction grating.

FIGS. 5A and 5B respectively show a block diagram of an apparatus 500 for generating a 3D representation in which illumination is directed on the centre of a scene and on the right-side of the scene. The apparatus 500 comprises a light source 502 (e.g. a VCSEL array). The light emitted by the light source 502 may pass through one or more optical elements 504 (e.g. lenses, mirrors, diffraction gratings, etc.) before being emitted from the apparatus 500 and projecting onto a scene/object field 508. The apparatus 500 may comprise a receiver lens and filter system 510, and a multipixel sensor/detector 512 for sensing reflected light. One or more of the optical elements 504 may be coupled to an actuation mechanism 506. The actuation mechanism 506 is arranged to move the optical element 504 to which it is coupled. The extent by which the optical element 504 is moved depends on the gain for the actuation mechanism 506. A control signal is provided to the actuation mechanism 506. The control signal is amplified by the gain. The amplified signal is applied to the actuation mechanism 506. FIG. 5A shows the optical elements 504 in their central or default position, which causes the emitted non-uniform illumination to project onto the centre of the scene 508 corresponding to the field of view of the sensor 512. FIG. 5B shows how one of the optical elements 504 may be moved by the actuation mechanism 506 in order to move the non-uniform illumination to different areas of the scene 508. In the illustration, moving an optical element 504 to the left of the figure may cause the non-uniform illumination to be projected on the right side of the scene 508. Thus, an actuation mechanism 506 may be used to steer the illumination onto specific objects or areas in the scene 508 during imaging, thereby illuminating the entire scene 506 with increased intensity such that the improved, increased image resolution may be achieved over a larger area.

Returning to FIG. 1, the actuation mechanism 110 may be used to move/steer the emitted non-uniform illumination in a scanning pattern across at least part of the field of view of the sensor 108. For example, FIGS. 3A and 3B respectively show a nine-point and a five-point scanning pattern using a circular beam. The scanning pattern may be a raster scanning pattern. The scanning pattern may be boustrophedonic. It can be seen from FIGS. 3A and 3B that increasing the number of points of the scan pattern may result in a more uniformly illuminated field of view, which may allow improved resolution across the whole field of view. However, the more points in the scans, the more frames which need to be captured and combined in order to generate the 3D representation. The more frames there are, the slower and more difficult it may be to combine the frames accurately, and there may be a greater chance of unresolvable discrepancy between the frames. In some cases, the scan pattern shown in FIG. 3B may be preferred where it is acceptable to sacrifice illumination in the corners of the field of view for improved coverage and better resolution near the centre of the field of view. Thus, the scanning pattern may be chosen to suit the application.

In FIGS. 3A and 3B, the non-uniform illumination is a substantially circular beam of light, which may simply be the far-field radiation pattern of the light source without any additional optics. A disadvantage of this type of illumination may be that large steering angles are required to ensure the illumination is projected across the whole field of view of the sensor 108. For example, for a 60° field of view, the illumination may need to be steered through roughly 40° along one axis (e.g. the horizontal axis) in order to cover substantially the whole field of view of the sensor 108 (i.e. the scene for which a 3D representation is to be generated). This may be difficult to achieve by directly moving the light source itself (or any other optical element) because of the difficulty making reliable electrical connections to something which needs to move large distances very rapidly and very frequently (e.g. millions of repeat cycles).

To reduce the amount by which the illumination needs to move in order for the illumination to cover substantially the whole field of view of the sensor 108 when a scanning pattern is applied, an illumination which is or comprises a pattern of light may be advantageous. Thus, optical elements, such as dot projectors or gratings, may be used to fill the object space field of view but with a low fill-factor. This ensures that bright illumination is projected onto the field of view, but reduces the required movement to illuminate the entire field of view when the illumination is moved in a scanning pattern across the field of view to approximately plus or minus half the average gap. FIG. 4A shows a six-point scanning pattern using a dot pattern of light, and FIG. 4B shows a three-point scanning pattern using a striped light pattern. In FIG. 4A, the scanning pattern comprises moving the illumination along two axes, e.g. side-to-side and up-and-down. Increasing the number of points in the scanning pattern may result in a more uniformly illuminated field of view, as described above. In FIG. 4B, the scanning pattern comprises moving the illumination along one axis e.g. side-to-side, or in one direction (e.g. left to right). Thus, having a striped illumination may be advantageous, and the actuation mechanism is only required to move an object unidirectionally. Thus, the scanning pattern implemented by the actuation mechanism may comprise moving the emitted non-uniform illumination along one axis across at least part of the field of view, or along two axes across at least part of the field of view.

With respect to patterned illumination (e.g. the patterns shown in FIGS. 4A and 4B), the pattern may be regular or irregular. This is in contrast to 3D sensing systems which use structured light emitters-here, there is a requirement that the projected pattern is sufficiently irregular such that the projected dots can be uniquely identified and mapped to their reflections. Furthermore, there is no requirement that the light of a ToF system to be accurately focussed on the object of interest/object being imaged, in contrast to the structured light systems.

Whatever type of illumination is used, the actuation mechanism may move the emitted non-uniform illumination to discrete positions in the field of view, or may move the emitted non-uniform illumination continuously across at least part of the field of view. This is because ToF measurement techniques rely only on illumination intensity over a period, and there is no need for the actuation mechanism to come to rest in order for the scene to be sampled.

The fill-factor for the field of view of the sensor 108 is greater after the scan than for the static beam shape. This can be seen by comparing the left hand image of FIG. 4A to the right hand image of FIG. 4A, or by comparing the left hand image of FIG. 4B to the right hand image of FIG. 4B. The fill-factor after the scan is affected by the accuracy with which the illumination is moved during the scan. If the distance moved between the positions is less than intended, then the portions covered will undesirably overlap with the portions covered by the preceding position. If the distance moved between positions is greater than intended, then similarly there will be undesirable overlap of the portions covered. This is shown in FIGS. 12-14.

FIG. 12 shows a dot pattern of light. FIG. 12 shows an idealised representation of the dot pattern projected by a typical ToF 3D sensing module. The dot pattern shown in FIG. 12 is regular. A pattern with irregularities may be used, for example depending on the type of 3D sensing. The present invention applies to both regular and irregular patterns.

FIG. 13 shows a scanning pattern using the dot pattern shown in FIG. 12. As part of the design process, a movement pattern is designed to achieve optimal fill-factor, or at least some trade-off for fill-factor versus number of steps (i.e. movements). The scanning pattern of FIG. 13 is formed by moving the illumination between each of four different positions. FIG. 13 shows the best packing for a four-step square movement pattern (four accumulated exposures). The four different positions are formed from two different position along one axis and two different positions along an orthogonal axis. The fill-factor for the static dot pattern shown in FIG. 12 may be about 0.22 (i.e. about 22% coverage of the field of view). The fill-factor for the scanning pattern shown in FIG. 13 may be about 0.86 (i.e. about 86% coverage of the field of view).

FIG. 14 shows another scanning pattern using the dot pattern shown in FIG. 12. The scanning pattern of FIG. 14 is formed when the gain for the actuation mechanism is not optimal. This causes the illumination to move too much or too little between the steps. If the gain of the actuator is higher or lower than nominal, then the fill-factor will fall. It can be seen from a comparison between FIG. 14 and FIG. 13 that the fill-factor for FIG. 14 (where the gain is not optimal) is lower than the fill-factor in FIG. 13 (where the gain is optimal).

The apparatus 102 may comprise a controller. The controller may comprise a microprocessor, working memory and program memory coupled to one or more of the components of the apparatus. The controller is configured to calibrate the actuation mechanism 110. In particular the controller is configured to determine a calibrated gain value for the actuation mechanism 110.

Optionally, the controller is arranged to set the gain (for the actuation mechanism 110) to each of a plurality of different gain values. The number of different gain values used may be, for example, at least two, at least four, at least eight, at least ten or at least 20.

Optionally, an approximation of the optimal gain may be provided before the controller determines the calibrated gain value. For example, an approximate optimal gain (or approximate range of gain values in which the optimal gain is expected to lie) may be made based on known information about the components and processes used to manufacture the actuation mechanism 110. The different gain vales set by the controller may be based on the approximate optimal gain (or approximate range of gain values in which the optimal gain is expected to lie). Alternatively, there may be no previously known approximate optimal gain value.

Optionally, the controller is arranged to, for each of the different gain values, control the actuation mechanism 110 to move the illumination in a scanning pattern across at least part of the field of view. For example, for the scanning pattern shown in FIG. 13, the controller controls the actuation mechanism 110 to cause the illumination to be moved along two axes to form the four different frames. Optionally, the controller is arranged to, for each of the different gain values, determine a fill-factor indicative of a proportion of the field of view covered by the illumination during a cycle of the scanning pattern.

Optionally, the controller is arranged to determine a calibrated gain value based on the determined fill-factors associated with the different gain values. The calibrated gain value is intended to be a best estimate of the optimal gain value, namely the gain that provides the optimal fill-factor. For example, the controller may determine the calibrated gain value as being a value between the two gain values that were associated with the highest fill-factors.

FIG. 15 is a graph to show the relationship between gain for the actuation mechanism and fill-factor for the field of view of the sensor 108. This can be transformed into the expected performance enhancement by taking the log₂ ratio versus the static case. This is shown in FIG. 16. FIG. 16 represents how much better the fill-factor is compared to if no scanning movement were applied.

As shown in FIG. 15, the fill-factor has a maximum. The maximum is associated with the optimal gain value. As the gain differs from the optimal gain value, the fill-factor decreases. A gain value of zero (i.e. the extreme left side of the x-axis) corresponds to there being no movement between exposures. This is equivalent to no scan being implemented. The fill-factor for a gain of zero is about 0.22 and corresponds to what is shown in FIG. 12. As the gain is increased from zero, the fill-factor increases as the amount of overlap between successive exposures decreases. As the gain continues to increase above the optimal gain value, the fill-factor decreases as the level of overlap between exposures increases.

The relationship between gain for the actuation mechanism and fill-factor for the field of view of the sensor 108 of FIG. 15 is specific to the illumination having a spatially-nonuniform intensity and scanning pattern of FIGS. 12-14. For different illumination and scanning patterns, the relationship may differ. For example, when the illumination pattern is irregular or pseudo-random, there may be multiple localized maxima in the relationship. However, a distinct peak in fill-factor can nonetheless be expected at the calibrated gain. Furthermore, the exact characteristic of the relationship will depend on the density of the structured light source. Relatively sparse illumination patterns may have a flatter peak around the calibrated gain, whereas denser illumination patterns may exhibit a smaller peak to trough separation in the higher gain region when multiple localized maxima are present.

By determining the calibrated gain value, the fill-factor can be increased. The calibrated gain value may be determined such that the fill-factor is maximised or at least increased compared to a situation in which a constant, predetermined gain value is used.

All suspension-based actuators, including SMA, require some form of gain calibration to deliver high-precision motion. The present invention is applicable to SMA actuation mechanisms or to other types of actuation mechanism. The technique of the present invention allows the necessary gain of the actuator for optimal (or at least improved) performance in a 3D scanning environment to be estimated without the need for a detailed or highly-controlled calibration environment and can be applied to any actuator technology. This technique could be deployed either as part of the factory calibration, or could be part of a dynamic runtime calibration. The calibration can be repeated so as to account for changing factors which can affect the actuation mechanism 110, such as ageing, contamination and the environment in which the apparatus 102 is used. It is possible to manufacture the apparatus 102 before the calibration is performed. This can help to speed up the production of the apparatus 102.

Optionally, the controller is arranged to determine the fill-factor based on reflected illumination received by the sensor 108. The calibration can be performed as an “in system” calibration. It is not necessary to measure actuator motion. Instead the effects of the actuator motion on the fill-factor are measured. It is not necessary to measure the projected pattern externally. Instead the received illumination is measured by the sensor 108 of the apparatus 102 itself. No other equipment may be required in order to perform the calibration.

The fill-factor associated with the different gain values is a suitable metric for optimisation (or at least improvement) of the actuation mechanism 110. The fill-factor depends on the accuracy with which the actuation mechanism 110 can be controlled. The fill-factor is therefore indicative of the accuracy of the actuation mechanism 110.

Optionally, the controller is arranged to determine that a portion of the field of view corresponding to a pixel of the sensor 108 has been covered by the illumination if the density of the reflected illumination received by the sensor 108 is above a threshold. The pixels of the sensor 108 are configured to measure the density of received light. The pixels may receive light which has been emitted by the apparatus 102 and has reflected off a surface. There may be additional sources of light such as background light.

In order to determine the fill-factor, the controller may determine whether or not the part of the field of view that corresponds to a given pixel has been covered by the illumination. If the pixel has detected only a small amount of light, then this may indicate that the corresponding portion of the field of view is not covered by the illumination. The light received by the pixel may be noise. By providing a threshold, the effect of noise or background light not resulting from the illumination can be reduced. The threshold may be predetermined in advance. Alternatively, the threshold may be adaptively determined, for example based on the overall amount of reflected illumination detected by the sensor 108.

Optionally, the different gain values are set and/or the calibrated gain is determined based on an optimisation algorithm. The optimisation algorithm may be, for example, gradient ascent or golden-section search. Other optimisation algorithms may also be used. Optionally, the controller is arranged to set the gain value based in part on the fill-factor determined for preceding set gain values. The controller is configured to apply an algorithm to determine the calibrated gain value quickly for a given number of iteration steps.

As mentioned above, optionally the scanning pattern comprises moving the illumination along one axis across at least part of the field of view. The axis may correspond to an axis along which the actuation mechanism 110 is configured to cause movement independent of another axis. The actuation mechanism 110 may be arranged to cause the illumination to move along each of two axes independently. The illumination may be caused to move along one of these axes. Alternatively, the movement may be along another direction that does not correspond to one of these axes.

Optionally, the scanning pattern comprises moving the illumination along two axes across at least part of the field of view. For example, as shown in FIG. 13 the scanning pattern may involve the illumination being moved along two orthogonal axes.

Optionally, the controller is arranged to determine a plurality of calibrated gain values for movement by the actuation mechanism along each of a corresponding plurality of axes. For example, a first calibration process may be performed to determine a calibrated gain value for movement of the illumination caused by the actuation mechanism 110 along a first axis. This calibration process may involve the illumination moving along only the first axis. The movement used in the calibration process may not correspond to the full scanning cycle that is used when the apparatus 102 is used for generating a 3D representation of the scene. For example, when a 3D representation of the scene is to be generated, the scanning pattern used may cover four frames corresponding to four different positions. However, when the calibration is performed to determine the calibrated gain value for movement along the first axis, the scanning pattern may have only two positions separated along the first axis (but omit the other two positions which are at different positions along a second, orthogonal axis). Accordingly, the fill-factors measured in the calibration process may be significantly lower than would be if all four positions were used.

A separate calibration process may be performed to determine the calibrated gain value for the second, orthogonal axis. Alternatively, the actuation mechanism 110 may be configured such that the same gain is applied for all degrees of freedom. Only one single calibration process may be performed in this case.

Optionally, for at least one of the gain values, the controller is arranged to control the apparatus 102 to perform a plurality of cycles of the scanning pattern. The scanning process is repeated. For each cycle of the scanning process the fill-factor may be determined. The controller is configured to determine the fill-factor for the gain value based on a combination of results from the cycles of the scanning pattern. For example, the determined fill-factor may be an average (e.g. a mean value or a median value) of the fill-factors for the different cycles of the scanning pattern. This can help to reduce the effect of noise on the results. When the signal to noise ratio is low, the accuracy of the determined fill-factor may be lower. By repeating the cycle, the accuracy of the fill-factor for the purposes of determining the calibrated gain value can be increased.

Optionally, the signal (to which the gain is applied) is indicative of a current for driving the actuation mechanism. The current may be a current applied to an SMA actuator wire. Alternatively, other types of control signals may be amplified by the gain to drive the actuation mechanism 110.

Optionally, the illumination is emitted towards a surface that diffusely reflects most of the illumination incident on it. The technique is desirable performed under controlled conditions. For example, the surface toward which the illumination is emitted may diffusely reflect the illumination. Diffuse reflection may produce more accurate measurements of the fill-factor compared to specular reflection (e.g. if the surface is a mirror or mirror-like). Desirably the surface reflects well. For example, the surface may reflect at least 80% of incident light (IR radiation). Desirably the distance from the apparatus 102 to the surface is known. Desirably the surface and the apparatus 102 are stationary relative to each other. This helps to reduce the noise level. Alternatively, a moving surface could be used to reflect the illumination for the calibration.

Desirably, it is possible to collect all the required data at a particular movement scale in only one iteration of the standard pattern and measurements taken in that condition can be assumed to be good. Alternatively, when the conditions are not so good (e.g. a moving surface, a surface with lower reflectivity, more specular reflection), then the measurements may be repeated to improve accuracy.

Additionally, the same algorithm can be employed even when the target is unknown and as long as there are sufficiently reflective surfaces in the field of view, the same type of optimisation can be run.

Optionally, the controller is arranged to detect the total amount of received IR energy (i.e. the sum of all pixels of the sensor 108). If the total amount of light received is below a threshold, then it may be determined that the calibration process cannot be reliably performed. This may be the case if, for example, the reflection is too low (e.g. the distance to a reflective surface is too high).

Optionally, the controller is arranged to detect the total amount of variation during a sweep of gain. If the amount of variation is below a threshold level, then this may be indicative of the received light actually being dominated by another IR source rather than the transmitted pattern. If the amount of variation is below a threshold level, then it may be determined that the calibration process cannot be reliably performed.

Optionally, the controller is arranged to detect noise in the individual measurements. Optionally, the controller is configured to take multiple frames to confirm the measurements. When the noise level is relatively high, the cycles of scanning patterns can be repeated and the results combined to improve the accuracy of the calibration.

Optionally the invention is embodied as a method for calibrating an actuation mechanism of an apparatus 102 for use in generating a three-dimensional representation of a scene. The method may be performed by a controller of the apparatus 102. The method may comprise controlling an imaging camera system 104 of the apparatus 102, the imaging camera system 104 comprising a multipixel sensor 108 and a light source 106 to emit illumination having a spatially-nonuniform intensity over the field of view of the sensor 108.

The method may comprise setting a gain for the actuation mechanism 110 to each of a plurality of different gain values, wherein the gain controls the extent to which the illumination is moved in response to a signal provided to the actuation mechanism 110.

The method may comprise, for each of the different gain values, controlling the actuation mechanism 110 to move the illumination in a scanning pattern across at least part of the field of view of the sensor 108, and determining a fill-factor indicative of a proportion of the field of view of the sensor 108 covered by the illumination during a cycle of the scanning pattern.

The method may comprise determining a calibrated gain value based on the determined fill-factors associated with the different gain values.

Referring to FIGS. 8A-E, certain examples of optical fields which can be produced by certain variations of the apparatus 102 of FIG. 1 will now be described. In each of these variations, the apparatus 102 includes a vertical cavity surface emitting Laser (VCSEL) as the light source 106.

FIG. 8A illustrates an optical field having a single high-intensity region 201. Within the region 201, the irradiance is broadly constant at the peak illumination intensity. This optical field can be achieved by using only the VCSEL 106 with no additional optical components. A simple lens element may be used to control the size of the region 201, thereby controlling the intensity of the peak illumination and the proportion of the field of view 200 of the sensor 108 that is illuminated (at a given distance, e.g. ˜3-10 metres). To scan the field of view 200 the region 201 must be steered through relatively large angles, as illustrated.

FIG. 8B illustrates an optical field with a pattern corresponding to a projection of the VCSEL pattern and with multiple high-intensity regions 202. Within each of these regions 202, the irradiance is approximately constant and is close to the peak illumination intensity. Each region 202 corresponds to the light emitted from a single VCSEL cavity. Therefore, the design of the VCSEL 106 determines the pattern of the optical field. To produce such a pattern, the apparatus 102 must generally include lens element(s) focused on the plane from which the VCSEL 106 emits. These lens element(s) may be a ball lens or a microlens array, as will be explained below with reference to FIGS. 10 and 11. The pattern is spread over the field of view 200 of the sensor 108. As illustrated, the steering angle required to scan the field of view 200 has been reduced considerably compared to FIG. 8A.

FIG. 8C illustrates an optical field with a pattern corresponding to a projection of the VCSEL pattern that has been split by a diffractive optical element or beam splitter. The pattern includes multiple high-intensity regions 203, within each of which the irradiance is approximately constant and is close to the peak illumination intensity. Corresponding regions 203 within each of the multiple copies of the VCSEL pattern correspond to the light emitted from a single cavity within the VCSEL 106. Therefore, the design of the VCSEL 106 determines the pattern within each of these copies. An optical element, such as a holographic diffractive element, is used to split the VCSEL pattern. This could split the VCSEL pattern into an M×N array. In the example shown, M=2 and N=2. The pattern is spread over the field of view 200 of the sensor 108. Compared to FIG. 8b (and with a similar VCSEL 106), the number of regions is higher and so the required steering angle is lower, as illustrated.

FIG. 8D illustrates an optical field corresponding to a single beam from the VCSEL 106 (cf. FIG. 8A) that has been split into a pattern of multiple beams 204 by a diffractive optical element or beam splitter. In particular, the optical element splits the input beam into a M×N array of output beams 204. In this example, the array is a 2×2 array. Various different types of optical elements could be used. As per FIGS. 8B-D, the pattern reduces the steering angle required to scan the field of view 200 of the sensor 108.

FIG. 8E illustrates an optical field corresponding to a single beam from the VCSEL 106 (i.e. made up from all the VCSEL cavities) that has been split into a series of stripes 205 using a suitable diffractive optical element. Such a pattern requires motion in only one direction in order to fill the field of view 200 of the sensor 108.

FIG. 9A-D, 10 and 11 illustrate certain variations of the apparatus of FIG. 1. In each of these variations, the apparatus 102 includes a VCSEL as the light source 106 and a set of one or more optical elements (hereinafter sometimes referred to as an optical stack). The pattern of non-uniform illumination produced by the VCSEL 106 and the optical stack can be steered around the field of view 200 of the sensor 108 by an actuation mechanism 110 corresponding to a miniature actuator, e.g. a SMA-based actuator. The optical stack may include lens elements for collimation of the light, diffractive optical elements for optical field control as well as additional lens elements to reduce distortion and improve performance.

FIG. 9A illustrates an example in which the miniature actuator 110 tilts a submodule 300 which is made up of the VCSEL 106 and the optical stack 301. The VCSEL 106 and the optical stack 301 have a fixed position and orientation relative to each other. By tilting the submodule 300 away from an optical axis, the light can be steered. In some example, the submodule 300 can be tilted in both directions away from the optical axis.

FIG. 9B illustrates an example in which the miniature actuator 110 is used to shift a lens 310 to steer the light. The optical stack also includes a collimation lens 311 and, in some examples, an optional diffractive element. In the illustrated example, the collimation lens 311 and the shift lens 310 are separate. However, the collimation lens and shift lens may be the same lens element as is the case in the example of FIG. 10 (see below). Translational movement of the shift lens 310 in directions perpendicular to the optical axis result in steering of the light.

FIG. 9C illustrates an example in which a mirror system 320 is used to steer the light. As in FIGS. 9A and 9B, the optical stack may include optional lens and diffractive elements 321. In this example, a system of two mirrors 320 is used to steer the light. By changing the angle between the mirror and the optical axis the pattern can scan the field of view 200 of the sensor 108. The light may be steered by a single actuated mirror capable of rotation about two orthogonal axes. Alternatively, each of the two mirror could be capable of rotation about a single axis, with the axes of the two mirrors being orthogonal. In another example, the apparatus 102 may have a single mirror and the VCSEL 106 may emit light at ˜90° to the final general direction.

FIG. 9D illustrates an example in which a pair of prisms 330 is used to steer the light. Again, the optical stack may include an optional collimation lens plus diffractive elements 331. The light can be steered by adjusting the relative orientation of the prisms 330 compared to each other and compared to the VCSEL 106.

FIG. 10 illustrates another example in which a ball lens 400 is used to project the pattern of the VCSEL 106 into the far field. The ball lens 400 has a short back focal length and so is positioned suitably close to the surface of the VCSEL 106. The back focal length for a ball lens with a diameter between 0.5 mm and 2 mm is typically below ˜0.3 mm.

The position of the pattern can be controlled by translating the ball lens 400 in a direction perpendicular to the direction D in which the light is generally emitted. The short back focal length increases the beam steering achieved for a given translation. Hence a miniature actuator 106 can readily be used to control the position of the lens 400.

The ball lens 300 may be constructed from optical glass, glass, plastic, or other optical materials, and may be coated with antireflective coatings specifically tuned to the wavelength of the VCSEL 106.

In FIG. 10, additional optical components (not shown) may also be included in the optical stack. For example, a diffractive optical element may be used to create a more detailed pattern, or an additional lens element may be added to reduce distortion of the pattern in the far field.

FIG. 11 illustrates an example with a microlens array 450 arranged in proximity to the VCSEL 106. The microlens array 450 is used to produce the pattern of illumination in the far field. The microlens array 450 is made up of multiple microlenses 450a. There is a microlens 450a over each individual VCSEL cavity 106a. The microlens 450a is preferably designed to collimate the light from each cavity 106a.

The position of the pattern in the far field can be controlled by translating the microlens array 450 in a direction perpendicular to the direction in which the light is generally emitted. Each microlens 450a can have a very short focal length so, again, relatively large steering angles can be achieved with relatively small displacements.

Alternatively, the microlens array 450 may have a fixed position relative to the VCSEL 106 and other optical elements in the apparatus 102 may be translated to steer the pattern of light. The microlens array 450, in both the actuated and static cases, may be included together with additional optical components in the optical stack. For example, a diffractive optical element may be used to create a more detailed pattern, or an additional lens element may be added to reduce distortion of the pattern in the far field.

The microlens might be manufactured at the wafer level to produce cost-effective miniature arrays.

A typical sensor 108 may have a field of view 200 of ˜62°×˜45°. The example illustrated in FIG. 10 involving the ball lens 400 may be able to achieve steering of between 0.025° and 0.07° per μm of shift/stroke. The example illustrated in FIG. 11 involving the microlens array 450 may require a significantly lower stroke for the same steering.

In embodiments, the illumination pattern could be selected to be non-uniform over the field of view, which could help provide selective enhancement of range and resolution in a particular field of view. For example, in embodiments, an initial scan of the field of view may be performed to identify one or more objects or regions of interest. Thereafter, the illumination may be concentrated onto the object(s)/region(s) of interest. Returning to FIG. 1, the ToF imaging camera 104 of the apparatus 102 may be arranged to perform an initial scan of the field of view to identify one or more objects/regions of interest in the field of view. Alternatively, a separate camera 112 may be used. For example, an optical camera 112 that is either part of the apparatus 102 or separate, may be arranged to perform an initial scan of the field of view to identify one or more objects/regions of interest in the field of view. However the initial scan is performed, the actuation mechanism may then move the emitted non-uniform illumination primarily across the identified one or more objects of interest in the field of view.

FIG. 2 shows a flowchart of example steps for generating a 3D representation of a scene using an apparatus or system described with reference to FIG. 1. The method begins at step S204 by emitting, using a time-of-flight (ToF) imaging camera system of the apparatus, non-uniform illumination onto the scene/field of view of a sensor (step S204). The method comprises moving, using an actuation mechanism of the apparatus, the emitted non-uniform illumination relative to, and across at least part of, the field of view of the sensor (step S206). The sensor/detector receives reflected light (step S208) and the time of flight (i.e. time taken between emitting the light and receiving the reflection) is used to determine the depth of the objects in the field of view (step S210). At step S212, the process checks if all exposures/frames have been obtained in order to generate the 3D representation. If not, the process returns to step S206. If yes, the exposures/frames are combined to generate a 3D representation (step S214).

Optionally, the method may begin by performing an initial scan of the field of view (step S200) and identifying one or more objects (or regions) of interest in the field of view (step S202). In this case, the step of moving the non-uniform illumination (step S206) may comprise moving the emitted non-uniform illumination across at least the identified one or more objects of interest in the field of view.

In embodiments, the emitted non-uniform illumination may be moved based on both the regions or objects of interest in the field of view and the intensity or signal-to-noise ratio of the received/detected reflected light. For example, if very little light is detected by the sensor/detector, the system may determine that the object/region of interest is too far away and so may move the illumination to a new position. Similarly, if the intensity of the reflected light is very high, then sufficient information about the field of view may be gathered relatively quickly, such that the illumination can be moved to a new position (to capture information about another object/region of the field of view) relatively quickly, whereas if the intensity of the reflected light is low, the illumination may need to be held in position for longer to allow enough information to be gathered to produce a reliable 3D image. Thus, in embodiments, the actuation mechanism may move the emitted non-uniform illumination in response to intensity and/or signal-to-noise ratio of sensed reflected light.

Embodiments are described above primarily in the context of a ToF camera. However, it is not essential for the imaging camera system to be a ToF camera. The imaging camera system may be any camera system configured to use projected light patterns and a camera system configured to detect incoming light. In general, the techniques according to the present invention may be applied to any apparatus arranged to emit illumination having a spatially-nonuniform intensity over the field of view of a sensor, where an actuation mechanism moves the illumination across at least part of the field of view, and where a gain for the actuation mechanism controls the extent to which the illumination is moved in response to a signal provided to the actuation mechanism.

For example, the techniques described herein for calibrating the gain may be applied to a structured-light 3D scanner. So, optionally the imaging camera system is or comprises a structured-light 3D scanner. The structured-light 3D scanner may comprise a projector configured to project structured light. Structured light has a known pattern. For example, the structured light may comprise a plurality of horizontal bars or a grid. The structured light may comprise a non-regular pattern, such as a pseudo-random pattern (e.g. a pseudo-random dot pattern). The structured-light 3D scanner is configured to detect deformation of the known pattern of the structured light. The structured-light 3D scanner may comprise a processor configured to calculate information of one or more surfaces onto which the structured light was projected based on the detected deformation.

An example of a structured-light 3D scanner is disclosed in WO 2019/193337 A1, which is herein incorporated by reference. The structured-light 3D scanner may incorporate a structured light projector (i.e. a component that projects patterned light, typically an array of dots), as well as a corresponding detector or sensor for detecting the reflected waves. The structured light projector may emit illumination having a spatially-nonuniform intensity over the field of view of the sensor, as described in relation to the ToF camera. As such, the gain calibration techniques according to the present invention can be applied equally to an actuation mechanism of a structured-light 3D scanner for moving the illumination across at least part of the field of view, wherein a gain for the actuation mechanism controls the extent to which the illumination is moved in response to a signal provided to the actuation mechanism.

Applying the gain calibration techniques of the present invention to a structured-light 3D scanner may thus be used to increase the fill-factor indicative of a proportion of the field of view of the sensor covered by the illumination during a cycle of the scanning pattern. While the fill-factor of structured light 3D scanners is desirable much less than unity, for example less than 0.5, it has been observed that there is some correlation between this fill-factor and the resolution of the structured-light 3D scanner. Increasing the fill-factor may thus improve resolution of the structured-light 3D scanner. So, the gain calibration techniques according to the present invention may be used to ultimately improve resolution of a structured light 3D scanner.

Embodiments of the invention are expected to make calibration of the actuation mechanism possible without requiring equipment external to the For example, an alternative way of calibrating the actuation apparatus. mechanism would be to use external capture equipment to record the movement of the scanning pattern. A persistence trace could be recorded showing the cumulative positions of the scanning pattern, i.e. recording information similar to what is shown in FIG. 13 or FIG. 14. A user could view such persistence traces for different gain values and manually adjust the gain to get the best visual fill factor. Embodiments of the invention do not require such external capture equipment, thereby making it cheaper to perform the calibration. Embodiments of the invention automatically calibrate the actuation mechanism, which is quicker and more reliable than manual adjustment of the gain that depends on a user's eyesight.

Embodiments of the invention are expected to make calibration of the actuation mechanism possible over a greater range of situations. For example, an alternative way of calibrating the actuation mechanism would be to perform traditional actuator measurements. No power is required to be provided to the illuminator because the illumination is not used. The movements of the actuation mechanism may be measured by measuring their displacement. However, such measurements require there to be a surface that is accessible from which the relevant motion can be accurately measured. Embodiments of the invention allow calibration to be performed even in situations when such a surface is not accessible.

It will be appreciated that there may be many other variations of the above-described embodiments.

For example, the optical element may be any one of: a lens, a prism, a mirror, and a diffraction grating.

The actuation mechanism may include a voice coil motor (VCM).

The actuation mechanism may be arranged to move the emitted illumination by moving any one of: a lens, a prism, a mirror, a dot projector, and the light source.

The apparatus may comprise an optical element arranged between the light source and the scene and the actuation mechanism may be arranged to spin or rotate the optical element.

References to the field of view of the sensor may refer to the field of view of the sensor plus any associated optical elements.

The present invention may relate to apparatus according to the following clauses:

1. An apparatus for use in generating a three-dimensional representation of a scene, the apparatus comprising: an imaging camera system comprising a multipixel sensor and a light source and arranged to emit illumination having a spatially-nonuniform intensity over the field of view of the sensor; an actuation mechanism for moving the illumination across at least part of the field of view, wherein a gain for the actuation mechanism controls the extent to which the illumination is moved in response to a signal provided to the actuation mechanism; and a controller configured to calibrate the actuation mechanism, the controller arranged to: set the gain to each of a plurality of different gain values; for each of the different gain values, control the actuation mechanism to move the illumination in a scanning pattern across at least part of the field of view, and determine a fill-factor indicative of a proportion of the field of view covered by the illumination during a cycle of the scanning pattern; and determine a calibrated gain value based on the determined fill-factors associated with the different gain values.

2. The apparatus according to clause 1 wherein the controller is arranged to determine the fill-factor based on reflected illumination received by the sensor.

3. The apparatus according to clause 2 wherein the controller is arranged to determine that a portion of the field of view corresponding to a pixel of the sensor has been covered by the illumination if the density of the reflected illumination received by the sensor is above a threshold.

4. The apparatus according to any preceding clause wherein the different gain values are set and/or the calibrated gain is determined based on an optimisation algorithm.

5. The apparatus according to clause 4 wherein the optimisation algorithm is gradient ascent or golden-section search.

6. The apparatus according to any preceding clause wherein the scanning pattern comprises moving the illumination along one axis across at least part of the field of view.

7. An apparatus according to clause 6 wherein the scanning pattern comprises moving the illumination along two axes across at least part of the field of view.

8. The apparatus according to any preceding clause wherein the controller is arranged to determine a plurality of calibrated gain values for movement by the actuation mechanism along each of a corresponding plurality of axes.

9. The apparatus according to any preceding clause wherein for at least one of the gain values, the controller is arranged to control the apparatus to perform a plurality of cycles of the scanning pattern and to determine the fill-factor for the gain value based on a combination of results from the cycles of the scanning pattern.

10. The apparatus according to any preceding clause wherein the imaging camera system is arranged to emit illumination that is a light beam having a circular beam shape, or comprises a pattern of parallel stripes of light, or comprises a pattern of dots or circles of light.

11. The apparatus according to any preceding clause wherein the signal is indicative of a current for driving the actuation mechanism.

12. The apparatus according to any preceding clause wherein the actuation mechanism comprises at least one shape memory alloy, SMA, actuator wire.

13. The apparatus according to any preceding clause wherein the actuation mechanism is configured to tilt a submodule comprising the light source and one or more further optical elements about at least one axis.

14. The apparatus according to any one of clauses 1 to 12 wherein the actuation mechanism comprises at least one lens movable in one or more orthogonal directions in a plane at least substantially parallel to an array of the light source to move the illumination across the at least part of the field of view.

15. The apparatus according to any one of clauses 1 to 12 wherein the actuation mechanism comprises at least one tilting mirror to steer the emitted illumination.

16. The apparatus according to any one of clauses 1 to 12 wherein the actuation mechanism comprises at least a pair of rotatable prisms to steer the emitted illumination.

17. The apparatus according to any preceding clause wherein the image camera system is a time-of-flight, ToF, imaging camera system.

18. A method for calibrating an actuation mechanism of an apparatus for use in generating a three-dimensional representation of a scene, the method comprising:
controlling an imaging camera system of the apparatus comprising a multipixel sensor and a light source to emit illumination having a spatially-nonuniform intensity over the field of view of the sensor;
setting a gain for the actuation mechanism to each of a plurality of different gain values, wherein the gain controls the extent to which the illumination is moved in response to a signal provided to the actuation mechanism;
for each of the different gain values, controlling the actuation mechanism to move the illumination in a scanning pattern across at least part of the field of view of the sensor, and determining a fill-factor indicative of a proportion of the field of view of the sensor covered by the illumination during a cycle of the scanning pattern; and
determining a calibrated gain value based on the determined fill-factors associated with the different gain values.

19. The method according to clause 18 wherein the illumination is emitted towards a surface that diffusely reflects most of the illumination incident on it.

20. A non-transitory data carrier carrying processor control code to implement the method of clause 18.

1. An apparatus for use in generating a three-dimensional representation of a scene, the apparatus comprising:
an imaging camera system comprising a multipixel sensor and a light source arranged to emit illumination having a spatially-nonuniform intensity over the field of view of the sensor;
an actuation mechanism for moving the illumination across at least part of the field of view, wherein a gain for the actuation mechanism controls the extent to which the illumination is moved in response to a signal provided to the actuation mechanism; and
a controller configured to calibrate the actuation mechanism, the controller arranged to:
set the gain to each of a plurality of different gain values;
for each of the different gain values, control the actuation mechanism to move the illumination in a scanning pattern across at least part of the field of view, and determine a fill-factor indicative of a proportion of the field of view covered by the illumination during a cycle of the scanning pattern; and
determine a calibrated gain value based on the determined fill-factors associated with the different gain values.

2. The apparatus according to claim 1, wherein the controller is arranged to determine the fill-factor based on reflected illumination received by the sensor.

3. The apparatus according to claim 2, wherein the controller is arranged to determine that a portion of the field of view corresponding to a pixel of the sensor has been covered by the illumination if the density of the reflected illumination received by the sensor is above a threshold.

4. The apparatus according to claim 1, wherein the different gain values are set and/or the calibrated gain is determined based on an optimisation algorithm.

5. The apparatus according to claim 4, wherein the optimisation algorithm is gradient ascent or golden-section search.

6. The apparatus according to claim 1, wherein the scanning pattern comprises moving the illumination along one axis across at least part of the field of view.

7. An apparatus according to claim 6, wherein the scanning pattern comprises moving the illumination along two axes across at least part of the field of view.

8. The apparatus according to claim 1, wherein the controller is arranged to determine a plurality of calibrated gain values for movement by the actuation mechanism along each of a corresponding plurality of axes.

9. The apparatus according to claim 1, wherein for at least one of the gain values, the controller is arranged to control the apparatus to perform a plurality of cycles of the scanning pattern and to determine the fill-factor for the gain value based on a combination of results from the cycles of the scanning pattern.

10. The apparatus according to claim 1, wherein the imaging camera system is arranged to emit illumination that comprises at least one of a light beam having a circular beam shape, a pattern of parallel stripes of light, or a pattern of dots or circles of light.

11. The apparatus according to claim 1, wherein the signal is indicative of a current for driving the actuation mechanism.

12. The apparatus according to claim 1, wherein the actuation mechanism comprises at least one shape memory alloy actuator wire.

13. The apparatus according to claim 1, wherein the actuation mechanism is configured to tilt a submodule comprising the light source and one or more further optical elements about at least one axis.

14. The apparatus according to claim 1, wherein the actuation mechanism comprises at least one lens movable in one or more orthogonal directions in a plane at least substantially parallel to an array of the light source to move the illumination across the at least part of the field of view.

15. The apparatus according to claim 1, wherein the actuation mechanism comprises at least one tilting mirror to steer the emitted illumination.

16. The apparatus according to claim 1, wherein the actuation mechanism comprises at least a pair of rotatable prisms to steer the emitted illumination.

17. The apparatus according to claim 1, wherein the imaging camera system comprises at least one of a time-of-flight imaging camera system or a structured-light 3D scanner.

18. (canceled)

19. A method for calibrating an actuation mechanism of an apparatus for use in generating a three-dimensional representation of a scene, the method comprising:
controlling an imaging camera system of the apparatus, the imaging camera system comprising a multipixel sensor and a light source to emit illumination having a spatially-nonuniform intensity over the field of view of the sensor;
setting a gain for the actuation mechanism to each of a plurality of different gain values, wherein the gain controls the extent to which the illumination is moved in response to a signal provided to the actuation mechanism;
for each of the different gain values, controlling the actuation mechanism to move the illumination in a scanning pattern across at least part of the field of view of the sensor, and determining a fill-factor indicative of a proportion of the field of view of the sensor covered by the illumination during a cycle of the scanning pattern; and
determining a calibrated gain value based on the determined fill-factors associated with the different gain values.

20. The method according to claim 19, wherein the illumination is emitted towards a surface that diffusely reflects most of the illumination incident on the surface.

21. A non-transitory data carrier carrying processor control code to implement the method of claim 19.
